(19) United States
(12) Patent Application Publication
(10) Pub. No.: US 2026/0225800 A1
(43) Pub. Date: Aug. 6, 2026

(54) AN ARRANGEMENT FOR HOUSEHOLD WASTE AND A METHOD FOR HANDLING HOUSEHOLD WASTE BY MEANS OF SUCH AN ARRANGEMENT

(71) Applicant: CleanGuard AB, Nacka Strand (SE)

(72) Inventor: Fredrik MAGNUSSON, Saltsjö-boo (SE)

(21) Appl. No.: 19/157,523

(22) PCT Filed: Feb. 12, 2024
(86) PCT No.: PCT/SE2024/050124

§ 371 Date: Aug. 18, 2025

(30) Foreign Application Priority Data
Feb. 20, 2023 (SE) 2350195-0

(51) Int. Cl. B65F 1/14

(52) U.S. Cl. CPC B65F 1/14; B65F 2210/116

(57) ABSTRACT

The present disclosure relates to an arrangement for household waste, the arrangement comprising: a container for household waste; a compression device arranged in the container for compressing the waste within the container; a cooling device arranged to provide a desired temperature within the container; and a control device configured to control the cooling device to freeze compressed waste within the container.

### TECHNICAL FIELD

The present disclosure relates to an arrangement for household waste and a method for handling household waste by means of such an arrangement. The present disclosure also relates to a computer program for such an arrangement. More specifically, the present disclosure relates to an arrangement for household waste, a method and a computer program as defined in the introductory parts of the independent claims.

### BACKGROUND ART

Increased awareness of our environment and how we as individuals affect the climate has led to an increased interest in recycling of household waste. This is more or less a necessity considering that the consumption per individual is rising and the population is increasing. The willingness to recycle is positive but households typically generate a lot of waste and it could be a challenge to handle it all. Household waste includes paper, plastics, metal, and food waste amongst others. For recycling purposes, a household may therefore need multiple garbage bins or recycling containers, one for each type of waste. One of the biggest problems with this is lack of space. Our homes/kitchens typically cannot accommodate all necessary containers and even if they do, the containers are small and are quickly filled up with waste. When the garbage bins/containers are full, it may either be picked up by household garbage collection providers or we may transport the waste ourselves to a public recycling station. To reduce the number of trips to the recycling station people typically tend to store some of the waste at some other place at home, in even larger containers or plastic bags, before taking everything to the recycling station. This tend to be both unhygienic and unpleasant.

To solve the problem with household waste taking up a lot of space in a home, the waste could be compressed. However, many solutions for compressing waste fail to retain the compacted shape of the waste when the compressing force is withdrawn. Also, many solutions require large and heavy arrangements for compression, which makes the actual space for waste even smaller. Another problem with such large known solutions is that they require a lot of material and a plurality of components, which is disadvantageous from a sustainability perspective.

Another problem with handling household waste is the hygienic factor. Storing a lot of waste for a long time may cause unpleasant odours and microorganisms to emerge. Some solutions exists where organic waste such as food residues is stored in a cold chamber.

While the prior art addresses some of the problems associated with household waste, they often fail to provide a compact and space-saving solution which optimizes the storage space for the waste and also addresses the hygienic aspects. There is thus a need for an improved arrangement for household waste.

### SUMMARY

It is an object of the present disclosure to mitigate, alleviate or eliminate one or more of the deficiencies and disadvantages in the prior art and solve at least one of the current problems.

It is a particular object of the present disclosure to provide an arrangement for household waste, which facilitates the handling of household waste.

Another object of the present disclosure is to provide an arrangement for household waste, which optimizes the storage space for the waste and is more hygienic and pleasant to use.

According to a first aspect of the present disclosure, there is provided an arrangement for household waste. The arrangement comprises: a container for household waste; a compression device arranged in the container for compressing the waste within the container; a cooling device arranged to provide a desired temperature within the container; and a control device configured to control the cooling device to freeze compressed waste within the container.

By compressing the household waste, space is freed up in the container to fill with more waste. The container can thereby accommodate more waste before it is full and has to be emptied. Also, by freezing the compressed waste in the container, the compressed waste will maintain its compressed state after compression and more space is freed up in the container. By freezing the compressed waste, the compressed waste will form a compact single unit (block), which is easy to fit into public waste bins at recycling stations. However, by freezing the waste, the adhesive function will automatically be dissolved after some time in normal environments due to the temperature and/or humidity. Thus, even if the waste is frozen in a block-like configuration when being transported to a public recycling station, the compressed unit will after some time dissolve and the waste will transition to separate items again. In some countries, there are laws and regulations regarding the shape and format of the waste at public recycling stations and freezing the waste is therefore very advantageous. Freezing the waste can also reduce the formation of bacteria and bad odours, which will make the handling of the household waste much more pleasant.

The control device may be configured to control the cooling device and/or the compression device.

Compression of the waste by means of the compression device may comprise dynamic compression and static compression. Dynamic compression is at the beginning of the compression process when the compression device starts applying a compression force on the waste and the waste is deformed and displaced inside the container. Static compression is when the waste has been compressed and the compression device applies a relatively constant compression force. Thus, during dynamic compression the compression force applied on the waste will gradually increase from zero, and, during static compression, the compression force is maintained at a predefined static compression force.

Preferably, the control device is configured to freeze the waste during compression thereof. This means that a compression force is applied to the waste by the compression device while the temperature is maintained below 0 degrees Celsius and until the waste is at least partly frozen. The control device may be configured to control the cooling device to provide a temperature below 0 degrees Celsius when the compression device is in the static compression state. Thus, freezing the waste may be performed during the static compression of the waste. This way, the waste will be frozen in the most compressed/compact state and more storage space will the available in the container. The frozen compact block of waste will be easy to bring to the recycling station and will easily fit into the openings of public waste bins.

According to an example of the present disclosure, the control device is configured to control the compression device, such that it is maintained in a static compression state during a predetermined time period. The user of the arrangement may decide the predetermined time period. The predetermined time period may be at least two hours, preferably at least three hours. The longer time the static compression is performed, and thus the freezing of the waste, the more likely it is that the waste will maintain the compressed state when the compression force is released. By controlling the time of compression, the compression force and the temperature within the container, a compact single block of waste can be achieved, which is hygienic and easy to handle.

The control device may be configured to control the cooling device to gradually reduce the temperature in the container during the static compression, down to a predetermined lowest temperature. The cooling device may be controlled to reach the lowest temperature when essentially half of the predetermined static compression time has passed. The predetermined lowest temperature may be between 0 and minus 15 degrees Celsius. Preferably, the predetermined lowest temperature is below −5 degrees Celsius, more preferably below −8 degrees Celsius, and most preferably below −10 degrees Celsius. When the predetermined lowest temperature has been reached, the cooling device may be controlled to gradually increase the temperature while maintaining it below zero as long as the static compression is performed. The control device may be configured to control the cooling device to provide a temperature below 0 degrees Celsius for some time after compression. The cooling device may provide a temperature below 0 degrees at least one hour after compression, preferably two hours.

The control device may be configured to control the cooling device to provide a temperature above 0 degrees Celsius at least when the compression device is in a non-compression state. Thus, when the compression device is in a non-compression state, the temperature may be above zero. This way, new waste will not freeze as it is inserted into the container. Typically, the cooling device is controlled to provide a non-freezing temperature between 0-10 degrees when the compression device is in a non-compression state. The cooling device may be controlled to provide a non-freezing temperature between 0-8 degrees, or preferably between 0-6 degrees Celsius when the compression device is in a non-compression state. The cooling device may thus be configured to provide a relatively cool environment within the container at all times. The low but non-freezing temperature will reduce the risk for microorganisms and unpleasant odours. The decrease in temperature from the non-freezing temperature to the subzero temperature may or may not start prior to static compression of the waste. In some embodiments, the decrease in temperature may start prior to dynamic compression, whereby the temperature may be around zero degrees at the start of dynamic compression.

The control device may be configured to control the compression device such that compression is initiated at a predetermined time. For example, the control device may be configured to initiate compression at a certain time each day. The control device may be configured to initiate compression at a time when the container normally is not used by any person, for example during the night. This way, the compression will not interfere with the use of the container and in the morning when the household might need to throw some garbage, space have been freed up in the container and there will be room for new garbage. It is to be understood that the control device could be configured to control the compression device to a compression state a plurality of times during the day. If the container is frequently used in the morning and in the evening, the control device may, for example, be configured to initiate compression at noon, and then again at midnight.

The container may comprise a bottom wall and sidewalls extending essentially vertically upwards from the bottom wall. The container may also comprise a top wall. The walls of the container delimits an inner volume or chamber of the container. The container may comprise one or more intermediate walls forming at least two separate chambers within the container. The different chambers may be used for different type of household waste. The cooling device may be arranged to enable freezing of household waste in at least one chamber of the container. In some embodiments, the cooling device may be arranged to enable freezing of household waste in only one of a plurality of chambers in the container.

The container may comprise a waste inlet, through which the waste is being inserted into the container. The waste inlet may be arranged at an upper end of the container. For example, the waste inlet may be an open top end of the container, or be an opening arranged in a top wall or a side wall of the container. The container may also comprise an openable and closable cover or lid for covering the waste inlet. The cover may be pivotally arranged. The cover may thus be hingedly connected to a container wall.

According to an example of the present disclosure, the compression device comprises at least one inflatable element configured to be inflated to compress the waste within the container. Alternatively, the compression device may comprise at least one movable press element configured to compress the waste within the container. The press element may comprise a plate or block arranged on a movable and retractable actuator e.g., in the form of a mechanical arm, a piston or similar. Such a movable actuator may be pneumatically, hydraulically or electrically controlled.

The compression device may be arranged to compress the waste laterally across the container, essentially perpendicularly to the direction of gravity. By compressing the waste essentially horizontally, some of the compressed waste will automatically (due to gravity) fall downwards towards the bottom wall of the container after compression of the waste. This way, movement of the waste is achieved and gaps and air pockets among the waste can be reduced. The compressed waste collection will thereby be more compact (higher density), more space is freed up and the container can accommodate more waste before it has to be emptied. Alternatively, the compression device is arranged to compress the waste vertically, preferably downwards towards the bottom wall or an intermediate and substantially horizontal wall of the container.

In the event that the compression device comprises at least one inflatable element, the at least one inflatable element is typically configured to expand in a direction towards a container wall and thereby compress the waste between the at least one inflatable element and the container wall. The at least one inflatable element of the compression device is configured to be inflated and thereby expand in size and volume. This way, the inflatable element will press the waste towards and against the container wall. In the compression state, the at least one inflatable element is inflated. The level of inflation may vary depending on the amount of waste in the container. In the non-compression state, the at least one inflatable element is configured to be deflated. This means that the at least one inflatable element has a reduced size and volume in the non-compression state compared to the compression state. Thus, by having an inflatable element, the compression device is compact and space saving and thereby has a minimal effect on the storage space for the waste in the container. This way, the household waste arrangement can be compact and still provide a relatively large storage space for the waste. Furthermore, it can be made lightweight and non-complex with a minimum of movable parts.

The compression device may further comprise an air source, such as an air pump, compressor, fan, turbine or similar, arranged in communication with the at least one inflatable element to inflate and/or deflate the inflatable element. The air source may be configured to provide a pressure of 0.1-3 bar inside the inflatable element during static compression. Preferably, the air source may be configured to provide a pressure of 0.3-0.7 bar inside the inflatable element during static compression. The air source may be connected to the at least one inflatable element via a first air passage. The air source may take air from an environment outside the container to inflate the inflatable element, and air inside the container may be discharged to the outside environment when the inflatable element is inflated. Alternatively, the air is circulated, such that the air source uses air from inside the container to inflate the inflatable element and such that the air is discharged back into the container upon deflation of the inflatable element. This way, smell of waste outside the container can be prevented. The compression device may further comprise a valve device arranged in fluid communication with the first air passage and the air source. The valve device is arranged to control the flow of air to and/or from the at least one inflatable element. The valve device may be referred to as a shunt. The air source and the valve device may be arranged underneath the bottom wall of the container, to not affect the storage space for the waste.

The compression device may comprise an inflatable element in each chamber of the container. Each inflatable element may be configured to occupy a substantial part of the volume of the chamber when it is in a fully inflated state. Each inflatable element may be configured to occupy a minor part and preferably an almost negligible part of the chamber volume when being completely deflated. The inflatable element may be arranged at a first side of the chamber and be configured to press the waste towards and against a container wall at a second side of the chamber. The second side of the chamber may be opposite to the first side of the chamber. The inflatable element may be arranged to rest substantially flat against the first side of the chamber when completely deflated.

According to an example of the present disclosure, the container comprises a hot zone, preferably for accommodating food residues, and a cold zone for accommodating other household waste, such as plastics and/or paper, wherein the cooling device is arranged in communication with the cold zone for enabling freezing of the waste accommodated therein. The container may thus be divided into a hot zone and a cold zone, wherein the temperature in the hot zone is higher than the temperature in the cold zone.

The container may comprise at least two chambers, wherein one of the chambers is arranged in or constitutes the hot zone and the other chamber is arranged in or constitutes the cold zone. In another example, the container comprises three chambers, wherein two chambers are arranged in the cold zone and one chamber is arranged in the hot zone. The cooling device may be configured to provide a cold zone temperature in the cold zone. The cooling device may comprise a cooler arranged in the cold zone. The household waste arrangement may further comprise a heating device arranged to provide a hot zone temperature in the hot zone. Alternatively, the cooling device comprises a cold side configured to provide the cold zone temperature, and a hot side configured to provide the hot zone temperature. This is advantageous in that a single device can be used to create both the cold zone and the hot zone. The cooling device may for example comprise a refrigerating device configured to remove heat from the cold zone and transfer it to the hot zone. In some embodiments, the cooling device may comprise a thermoelectric module, such as a Peltier module or Peltier pad, having a cold side facing the cold zone and a hot side facing the hot zone. In the hot zone, the hot zone temperature may be between 0-50 degrees, preferably between 20-50 degrees. The hot zone temperature may be slightly above room temperature. The hot zone temperature may be relatively constant. In the cold zone, the temperature may be between minus 15 to plus 10 degrees. Food residues are often wet, sticky and/or gooey and would not be suitable to freeze because of the relatively large amount of water in it. By having food residues in the hot zone, the food residues can be dried and the amount of water in the food waste can be reduced, thereby leaving room for more food residues in the container. It is also hygienic since decomposition of food residues can be prevented by drying the food residues in the hot zone, while at the same time preventing bacterial growth and odours by cooling other household waste, such as paper and/or plastic waste, in the cold zone. Also from an energy perspective, it may be advantageous to prevent decomposition of food residues, or at least to interrupt or decelerate decomposition of food residues at an early stage of decomposition, since the energy stored in non-decomposed food residues may be more efficiently recycled at a later stage of the waste-recycling process.

According to an example of the present disclosure, the household waste arrangement further comprises an arrangement for alternately exposing the waste in the container for the hot zone and the cold zone. As described above, food waste may normally be accommodated in the hot zone. By allowing the food waste to also be exposed to the cold zone, the risk for microorganisms and unpleasant odours in the food waste can be reduced. Similarly, plastics and/or paper may normally be accommodated in the cold zone. However, by allowing such waste to also be exposed to the hot zone, the heat could smooth out the plastics and/or the paper and thereby affect the shape of the waste. This way, the waste may be made to move around inside the container and gaps and air pockets among the waste can be reduced. The waste can thereby be made to occupy less space, thereby leaving room for more waste in the container.

The arrangement for alternately exposing the waste in the container for the hot zone and the cold zone may comprise means for temporarily expanding the cold zone and/or the hot zone and thereby exposing the household waste for alternating temperatures. The container may comprise a plurality of chambers and at least one may be in the cold zone and at least one may be in the hot zone. Expanding the cold zone may comprise transferring cold air from the cold zone into the hot zone. This way, the cold zone will encompass also the previous hot zone. The hot zone will thus temporarily be part of the cold zone. Expanding the hot zone may comprise transferring hot air from the hot zone into the cold zone. This way, the hot zone will encompass also the previous cold zone. The cold zone will thus temporarily be part of the hot zone. The means for temporarily expanding the cold zone and/or the hot zone may comprise a fan arranged in fluid communication with the hot zone and the cold zone. By controlling the fan, hot air can be drawn from the hot zone into the cold zone or vice versa.

The arrangement for alternately exposing the waste in the container to the hot zone and the cold zone may alternatively comprise means for displacing household waste between the hot zone and the cold zone and thereby exposing the household waste for alternating temperatures. The container may comprise at least one displaceable intermediate wall, which in its normal position delimits two different chambers inside the container. When the displaceable intermediate wall is in its normal position, household waste on one side of the intermediate wall is in the cold zone and household waste on the other side of the intermediate wall is in the hot zone. By displacing the household waste in the hot zone in direction towards the cold zone, or displacing the household waste in the cold zone in direction towards the hot zone, and thereby also displacing the intermediate wall, the household waste can alternately be exposed to the cold zone and the hot zone. The means for displacing the household waste may comprise another displaceable intermediate wall. Alternatively, the means for displacing the household waste may comprise a mechanically, electrically, pneumatically or hydraulically controlled actuator arranged to move inside the container.

It should be appreciated that the above-described features relating to a hot zone and cold zone of the household waste arrangement are not depending on the previously described features relating to compression of waste. Consequently, it should be understood that embodiments of the household waste arrangement disclosed herein could comprise a hot zone and a cold zone but no compression device. Likewise, it should be understood that the household waste arrangement could comprise an arrangement for alternately exposing the waste in the container for the hot zone and the cold zone, without comprising any compression device.

Notwithstanding the above, one or more compression devices may be advantageously used for compressing the waste in any or both of the cold zone and the hot zone. For example, the household waste in the cold zone may be frozen during compression to obtain the above-discussed advantages. To this end, the temperature of the cold zone and a compression device for compressing waste in the cold zone can be controlled in accordance with the above-described principles for freezing compressed waste. Instead or in addition to a compression device for compressing waste (typically plastics and/or paper) in the cold zone, the household arrangement may comprise a compression device for compressing waste (typically food residues) in the hot zone. This is advantageous since the amount of water in the food residues is reduced by being exposed to the hot zone, thereby facilitating compression of food residues and making the compressed food residues more compact. In embodiments employing an arrangement for alternately exposing the waste in the container to the hot zone and the cold zone, household waste containing plastics and/or paper may advantageously be exposed to the hot zone to smooth out and flatten the plastics and/or the paper waste before it is exposed to the cold zone where it may be compressed and frozen. This way, an even more compact unit of frozen plastics and/or paper may be obtained. Also, in such embodiments, food residues could first be dried in the hot zone before being exposed to the cold zone where they may be compressed and frozen.

In embodiments employing both a cold zone and a hot zone and one or more compression devices for compressing waste in any or both in the cold zone and the hot zone, a compression device may further be controlled to achieve circulation of air within the container, such that cold air from the cold zone is pushed into the hot zone, or vice versa. Thereby, the compression device may facilitate a temporary expansion of the cold zone into the hot zone, or vice versa, and thereby exposing the household waste to alternating temperatures, as described above.

According to an example of the present disclosure, the arrangement for household waste further comprises a flexible receptacle removably arranged inside the container for receiving the waste. The compression device may be arranged to compress the waste by compressing the receptacle. The flexible receptacle may thus be positioned inside the container to be filled with waste, and when the receptacle is full, it can be removed from the container to be emptied. The receptacle may thus easily be brought to the recycling station where it is emptied. By using the flexible receptacle, the container and compression device are separated from the waste and it will be easier to keep the container and the compression device clean. The receptacle is arranged inside the container, such that the receptacle is arranged between two opposite walls of the container and the compression device is arranged between the receptacle and a first of the opposite container walls. The compression device will thereby exert a force on the receptacle in a compression state, and the receptacle will be compressed and pushed against the opposite container wall, thereby compressing the waste inside the receptacle. Thus, during compression of the waste, the receptacle will be deformed. Specifically, the compression device presses on a first wall of the receptacle, such that the first wall is moved in direction of an opposite second wall of the receptacle, whereby the waste is compressed between the first and second wall of the receptacle by the compressing device when pressing the receptacle against the opposite container wall.

The household waste arrangement may comprise a flexible receptacle in each chamber of the container. Thus, in the event that the container comprises three chambers, the arrangement may also comprise three receptacles, one in each chamber. The means for displacing household waste between the hot zone and the cold zone may involve means for displacing a receptacle with household waste between the hot zone and the cold zone.

The container may comprise a closable opening for inserting and removing the receptacle(s) into and out from the container. The closable opening may be arranged at the upper end of the container. Alternatively, the closable opening for inserting and removing the receptacle is arranged in a sidewall of the container. The closable opening may be the same as the waste inlet or it may be a separate opening.

According to an example of the present disclosure, the household waste arrangement is configured to moisten household waste within the container before compression. By moistening the waste, compression of the waste may be facilitated. Moistening the waste before compression may also help maintaining the compressed state of the waste when the compressing force is released. Also, when freezing the waste during compression, moistening the waste before compression will increase the adhesion between the waste when being frozen. Typically, household waste in the cold zone is moistened before compression. The arrangement may be configured to moisten the household waste just before compression. The arrangement may be configured to moisten household waste in the cold zone at a non-freezing temperature just before compression. As an example, the temperature and the moisture in the cold zone are controlled, such that the temperature is at or near a maximum temperature, essentially when the household waste is moistened.

The arrangement may comprise a humidifying device arranged in fluid connection with the inside of the container, wherein the humidifying device is arranged to provide a fluid to moisten the waste before compression. The fluid may be provided in the form of a liquid or a vapour. The fluid may comprise water. The fluid provided by the humidifying device may comprise starch or any other biological binder. The fluid will thereby act as a temporary adhesive gluing the waste together in the compressed state. Additionally or alternatively, the fluid provided by the humidifying device may comprise disinfectant and/or scented liquid. Applying a disinfectant to the waste is advantageous from a hygiene perspective to avoid harmful bacteria or other vermin. Applying a scented liquid may help avoiding unpleasant odours from the waste and may thereby increase the well-being.

The humidifying device may comprise at least one reservoir for a fluid arranged on the container and at least one nozzle or discharge aperture arranged to discharge the fluid into the container. The humidifying device may for example comprise one reservoir for a fluid comprising water and starch, and another reservoir for a scented liquid. The at least one reservoir is suitably arranged at the outside of the container to increase the accessibility. The at least one nozzle or discharge aperture may be configured to provide the fluid as an aerosol and thus spray the fluid over the waste. This way, the fluid will be distributed over the waste in an efficient way. When the container comprises two or more chambers, the humidifying device may comprise two or more nozzles or discharge apertures connected to the at least one reservoir, thereby enabling the fluid to be discharged on the waste in each chamber.

In one example, the arrangement is configured to take moisture generated by evaporation of food residues in the hot zone to humidify waste in the cold zone. Thus, vapour from the food residues in the hot zone will be transferred to the cold zone where it will condensate and moisten the household waste in the cold zone. The natural moist in the food residues is this way used and a very energy efficient way of moistening the waste in the cold zone is achieved at the same time as the amount of water in the food residues is reduced. The arrangement may comprise a humidification fan arranged between the hot zone and the cold zone. The fan may be controlled to draw the vapour from the hot zone into the cold zone.

In one example of the present disclosure, the control device is configured to control the compression device to perform a pre-compression operation to move the waste around inside the container. In the pre-compression operation, the compression device is controlled to provide a compression force for a short period of time. Said short period of time is typically not long enough for the waste to maintain a compressed state after the pre-compression operation. Thus, in the pre-compression operation, the control device is configured to control the compression device to briefly compress the waste. The control device may thus be configured to control the compression device to briefly provide a compression force on the waste. Typically, the compression device is controlled to briefly compress the waste about 3-5 times during the pre-compression operation. The pre-compression operation may be performed during a predetermined period of time. The pre-compression operation is advantageously performed just before compressing the waste. This way, the waste will be moved around inside the container and gaps and air pockets may be avoided and once the compression starts, the compressed waste may become more compact. Alternatively, the control device may be configured to control the compression device to perform the pre-compression operation anytime during the day, to move/shake the waste in the container and free up space for more waste. Thus, the pre-compression operation can be described as a compress-and-release movement by the compression device, which movement is repeated a plurality of times, typically 3-5 times, in order to make the waste in the container more compact and free up space for more waste. The arrangement may be configured to perform the pre-compression operation and moisten the waste at the same time. This way, the waste will be moved around inside the container and the fluid will be more evenly distributed on the waste.

The control device may be configured to control the compression device based on user input. The control device may be operatively coupled to a user input device, such that the user of the arrangement can override any predetermined automatically initiated compression or initiate compression manually at any time. Such user input device may comprise a mobile electronic device of the user, which mobile electronic device is operatively coupled to the control device, e.g. via a network server. Such mobile electronic device of the user may be a mobile phone or a tablet computer. By allowing the compression device to be controlled based on user input from a mobile electronic device, the user can start or end compression from anywhere, even when being remote from the arrangement. This way, a user, which is away from home for many hours during the day, can start compression of the waste, even if the arrangement is programmed to perform compression during the night when no one uses the container. Increased flexibility is thereby achieved. Additionally or alternatively, the arrangement may comprise a user input device in the form of a manoeuvring element, such as a button, lever or switch operatively coupled to the control device. Such manoeuvring element may be provided on the container. By manoeuvring the manoeuvring element, the user can manually start and/or end compression of the waste.

The arrangement may comprise a non-stick arrangement for preventing adhesion between the receptacle(s) and the waste during compression. The waste in the receptacle could be all sorts of waste and may comprise sticky residues, which could cause adhesion between the receptacle and the waste. This could make it messy and complicated to empty the receptacle when it is full with waste and it could also prohibit reusing the receptacle after compression. With the non-stick arrangement, emptying the receptacle is facilitated and the waste will easily fall out of the receptacle for example when being turned up-side down. The need of having to manually withdraw waste out of the receptacle is thereby reduced. Adhesion between the receptacle and the waste may also prevent the receptacle from regaining its original shape after compression, when the inflatable element is deflated, and it would thereby be difficult to insert more waste into the receptacle after compression. Adhesion between the receptacle and the waste should therefore be avoided and this can be achieved by means of the non-stick arrangement according to the present disclosure.

The non-stick arrangement may comprise a non-stick coating on an inner wall of the receptacle. The non-stick coating is advantageously configured to reduce the ability of other material to stick to it and may comprise polytetrafluoroethylene (PTFE), ceramic coatings, silicon coatings or super hydrophobic coatings. The non-stick arrangement may thus form part of the receptacle. The receptacle may comprise the non-stick coating on at least one inner wall. The non-stick coating is suitably provided on the inner side of the wall abutting the press element or inflatable element of the compression device. Alternatively, the receptacle comprises the non-stick coating on all its inner walls. Having a receptacle that comprises the non-stick arrangement, allows the receptacle to be reused after being emptied. The non-stick coating will facilitate cleaning of the receptacle and the receptacle can be used multiple times.

Alternatively, the non-stick arrangement may comprise an intermediate non-stick element configured to be arranged between an inner wall of the receptacle and the waste. The non-stick element may be formed as a tongue, sheet or liner. The non-stick element may be pivotally attached to the container. When the receptacle is to be arranged into the container, the non-stick element may be pivoted outwards from the container and once the receptacle is positioned inside the container, the non-stick element can be pivoted inwards over a wall of the receptacle, to be arranged between the inner wall of the receptacle and the waste being inserted into the receptacle. A similar procedure may be performed when removing the receptacle from the container. During compression, one side of the non-stick element will abut the inner wall of the receptacle and the other side of the non-stick element will abut the waste. The non-stick element may be configured to be removably arranged inside the receptacle. By using a separate non-stick element, which can be removed from inside the receptacle, it can easily be cleaned and replaced in case it is worn out or damaged. Furthermore, with a separate non-stick element any type of flexible receptacle can be used for accommodating the waste. For example, a disposable receptacle can be used, such as a paper or plastic bag.

In some examples, the receptacle comprises a resilient material allowing the receptacle to regain its original shape after compression. The receptacle may comprise rubber or silicone. With a material that allows the receptacle to regain its original shape after compression and deformation, the receptacle can easily be used again after compression. In some embodiments, the receptacle comprises a material, which allows the receptacle to automatically regain its original shape when the compression force applied on the receptacle is released. The receptacle may additionally or alternatively have a shape or design that allows the receptacle to automatically regain its original shape when the compression force applied on the receptacle is released. The receptacle may comprise folding lines, slits or similar features for facilitating deformation during compression. The receptacle may comprise a resilient material allowing the receptacle to be turned inside out. This way, emptying of waste is facilitated.

The receptacle may comprise at least one handle, a hook or similar to facilitate holding the receptacle while it is being emptied.

In some embodiments, the arrangement for household waste comprises a shape regaining arrangement for facilitating the receptacle to regain its original shape after compression. Specifically, the arrangement for household waste may comprise a shape regaining arrangement for facilitating the receptacle to regain its original shape after compression.

Due to the compression and depending on the type of waste, the receptacle may require some help to regain its original shape after compression. Manually reshaping the receptacle after compression could be messy and it would therefore be advantageous to have an arrangement for facilitating the receptacle to regain its original shape.

The shape regaining arrangement may comprise at least one coupling element arranged to removably attach the receptacle to the compression device and/or the container. The shape regaining arrangement may comprise a first coupling element on the receptacle and a second coupling element on the compression device and/or the container. By having a first coupling element on the receptacle connected to a second coupling element on the compression device, the receptacle wall comprising the first coupling element would follow the movement of the compression device when it is retracting or deflating to a non-compression state. The first coupling element may be arranged in association with a first wall of the receptacle that is abutting the compression device. When the compression device moves towards the waste and applies a compression force, it will deform and compress the receptacle such that the first wall of the receptacle is pressed towards a second opposite wall of the receptacle. When the compression device moves away from the waste, the first wall being connected to the compression device would follow the movement of the compression device and the first wall would thus move in direction away from the second wall. This way, the receptacle would be regaining its original shape in an easy way. The shape regaining arrangement may further comprise at least one other coupling element arranged to removably attach the second wall of the receptacle to a container wall adjacent to the second wall of the receptacle, to prevent the whole receptacle from being displaced when the compression device is retracting or deflating after compression. The shape regaining arrangement may comprise a magnet coupling. The shape regaining arrangement may alternatively comprise a Velcro coupling, a suction cup coupling or a hook and loop coupling or similar.

In another example, the first coupling element may be arranged in association with a first wall of the receptacle that is abutting the compression device and the second coupling element is arranged on the container wall adjacent to or behind the compression device. In this case, the second coupling element and/or the first coupling element may be flexible or elastic, such that it can be stretched or expanded and the connection between the coupling elements is maintained when the compression device compresses the waste. During compression, the first and/or second coupling element will be stretched as the first wall of the receptacle comprising the first coupling element is moved away from the container wall comprising the second coupling element. When the compression device is retracted, it will no longer stretch the coupling element(s) and the configuration of the first and/or second coupling element will automatically pull the first wall of the receptacle away from the second wall of the receptacle, and the receptacle would regain its original shape.

The shape regaining arrangement may alternatively be configured to generate a pressure difference between the inside of the receptacle and a space between the receptacle and the container to affect the shape of the receptacle after compression. The shape regaining arrangement may thus comprise means for generating a pressure difference between the inside of the receptacle and a space between the receptacle and the container to affect the shape of the receptacle. This way, the pressure difference will affect the receptacle walls, such that the receptacle regains its original shape. In one example, the shape regaining arrangement is configured to increase the pressure inside the receptacle, such that the higher pressure will push the walls of the receptacle outwards, towards the container walls. Alternatively, or in addition, the shape regaining arrangement is configured to reduce the pressure in the space between the receptacle and the container, such that an under pressure is achieved, whereby the walls of the receptacle will be pulled (sucked) outwards towards the container walls. The shape regaining arrangement may thus comprise an air source, such as an air compressor, air pump or similar. Suitably, the air source of the shape regaining arrangement is the same air source as in the compression device in the event that the compression device comprises at least one inflatable element. Thus, the same air source can be used to compress the waste and help regaining the original shape of the receptacle after compression. The shape regaining arrangement may also comprise at least one passage in fluid connection with the inside of the receptacle and/or the space between the receptacle and the container and the air source.

The arrangement may further comprise a lifting arrangement for facilitating lifting the receptacle(s) out of the container. The lifting arrangement may comprise a second inflatable element arranged underneath the receptacle, wherein the second inflatable element is configured to be inflated to push the receptacle upwards. The receptacle will this way be lifted in relation to the container and it will be easier for the user to remove the receptacle from the container. The second inflatable element may be connected to the air source of the compression device via a second air passage. The air source of the compression device may thus be configured to provide air through the second air passage to the second inflatable element. Alternatively, the lifting arrangement comprises a second air source for inflating the second inflatable element.

It is to be understood that in the event that the arrangement comprises two or more receptacles, the non-stick arrangement may be configured to prevent adhesion between the waste and each receptacle. Thus, the non-stick arrangement may comprise a non-stick coating on each receptacle or two non-stick elements, one arranged between each receptacle and the waste in the respective receptacle. Furthermore, the shape regaining arrangement may be configured for facilitating all receptacles to regain its original shape after deflation of the inflatable element(s). The shape regaining arrangement may thus comprise a first coupling element on each receptacle, and a corresponding second coupling element on the inflatable element(s) or the container. Alternatively, the shape regaining arrangement may be configured to generate a pressure difference between the inside of each receptacle and the space between the receptacle and the container.

The first aspect of the present disclosure also provides a method for handling household waste by means of an arrangement for household waste. The arrangement comprises a container for household waste; a compression device arranged in the container for compressing the waste within the container; a cooling device arranged to provide a desired temperature within the container; and a control device, the method comprising: compressing household waste within the container by means of the compression device; and controlling the temperature within the container by means of the cooling device, wherein the step of controlling the temperature comprises controlling the cooling device to freeze compressed waste within the container. It is to be understood that all features and advantages mentioned with regard to the arrangement above are also applicable on the method. The method is preferably a computer-implemented method performed by means of the control device described herein.

The step of compressing the waste may comprise compressing the waste laterally across the container, essentially perpendicularly to the direction of gravity. Alternatively, compressing the waste is performed essentially vertically.

The step of compressing the waste may comprise compressing the waste by compressing a flexible receptacle removably arranged inside the container for receiving the waste.

The step of controlling the temperature may comprise controlling the cooling device to provide a temperature below 0 degrees Celsius when the compression device is in a static compression state.

The step of controlling the temperature may comprise controlling the cooling device to provide a temperature above 0 degrees Celsius at least when the compression device is in a non-compression state.

The method may further comprise the step of alternately exposing the waste in the container for a hot zone and a cold zone within the container.

Alternately exposing the waste in the container for a hot zone and a cold zone within the container may comprise temporarily expanding the cold zone and/or the hot zone. This may include controlling a fan to draw hot air from the hot zone into the cold zone or vice versa. Alternatively, this may include controlling a compression device in the hot zone to push hot air in the hot zone over to the cold zone, or vice versa.

Alternately exposing the waste in the container for a hot zone and a cold zone within the container may comprise displacing household waste between the hot zone and the cold zone. Displacing household waste may be performed by displacing the receptacle comprising the household waste. Displacing the household waste may involve pushing a displaceable intermediate wall between the hot zone and the cold zone.

The method may further comprise moistening the waste before compression. Moistening the waste before compression may comprise taking moisture generated by evaporation of food residues in the hot zone to humidify waste in the cold zone. Moistening the waste before compression may comprise moistening the waste by means of a humidifying device arranged in fluid connection with the inside of the container.

The method may further comprise facilitating that the receptacle regains its original shape after compression, by means of a shape regaining arrangement. Facilitating that the receptacle regains its original shape may comprise generating a pressure difference between the inside of the receptacle and a space between the receptacle and the container as described above. The control device may thus control the shape regaining arrangement, such that a pressure difference between the inside of the receptacle and a space between the receptacle and the container is generated.

According to the first aspect of the present disclosure, a computer program for an arrangement for household waste is also provided. The arrangement for household waste comprises a container, a compression device and a control device comprising at least one processor, the computer program comprising computer-readable instructions which, when executed by the at least one processor causes the arrangement for household waste to perform the steps of the method as disclosed herein. Furthermore, according the first aspect of the present disclosure there is provided a computer program product comprising at least one computer-readable medium, such as a non-transitory memory, storing the above mentioned computer program.

As discussed above, the features relating to a hot zone and cold zone of the household waste arrangement are not depending on the features relating to compression of waste, and the household waste arrangement may be provided with a hot zone and a cold zone without being provided with a compression device.

Thus, according to a second aspect of the present disclosure, there is provided an arrangement for household waste comprising a container for household waste, wherein the container comprises a hot zone for accommodating food residues and a cold zone for accommodating other household waste, such as plastics and/or paper. Having a hot zone for food residues is advantageous because it will help drying the food residues, which will that way become less bulky. Having a cold zone for accommodating other household waste will reduce the risk for microorganisms and unpleasant odours.

The arrangement according to the second aspect may comprise a cooling device arranged to provide a desired temperature within the container. More specifically, the cooling device may be arranged to provide a hot zone temperature in the hot zone, and a cold zone temperature in the cold zone. The hot zone temperature may be between 0-50 degrees Celsius. In some embodiments, where the waste is not frozen but kept cold to prevent bacterial growth and unpleasant odours, the temperature in the cold zone may be between 0 to 10 degrees. In other embodiments, where the waste in the cold zone is frozen for hygienic and/or practical reasons, as discussed above with regard to the first aspect of the present disclosure, the temperature in the cold zone may be between minus 15 to plus 10 degrees Celsius.

The cooling device may be configured as described above with regard to the first aspect of the present disclosure. Thus, the cooling device may be a single device having a cold side configured to provide the cold zone temperature, and a hot side configured to provide the hot zone temperature.

The arrangement according to the second aspect may further comprise an arrangement for alternately exposing the waste in the container for the hot zone and the cold zone. The arrangement for alternately exposing the waste in the container for the hot zone and the cold zone may be configured as described with regard to the first aspect of the present disclosure. Thus, it may comprise means for temporarily expanding the cold zone and/or the hot zone and thereby exposing the household waste for alternating temperatures or it may comprise means for displacing household waste between the hot zone and the cold zone and thereby exposing the household waste for alternating temperatures.

The arrangement according to the second aspect of the present disclosure may further comprise a compression device arranged to compress the waste within the container. The compression device may be configured as described with regard to the first aspect of the present disclosure.

The arrangement according to the second aspect of the present disclosure may further comprise a control device, configured to control the cooling device and/or the compression device. The control device may be configured to control the temperatures in the hot zone and the cold zone and/or the compression device as described above with regard to the first aspect of the present disclosure.

With regard to the second aspect of the present disclosure, a method for handling waste by means of an arrangement for household waste is provided. The arrangement comprises a container for household waste, a cooling device and a control device configured to control the cooling device, wherein the method comprises controlling the cooling device to provide a hot zone and a cold zone within the container.

The method may comprise alternately exposing the waste in the container for the hot zone and the cold zone. This may be performed similarly as described with regard to the first aspect of the invention.

The method may further comprise compressing the waste within the container. Controlling the cooling device may then comprise controlling the cooling device to provide a temperature below 0 degrees in the cold zone when the compression device is in a static compression state.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the appended claims.

### BRIEF DESCRIPTIONS OF THE DRAWINGS

The above objects, as well as additional objects, features and advantages of the present disclosure will be more fully appreciated by reference to the following illustrative and non-limiting detailed description of example embodiments of the present disclosure, when taken in conjunction with the accompanying drawings, of which:

FIG. 1 illustrates an exemplary embodiment of an arrangement for household waste according to the present disclosure;

FIG. 2 schematically illustrates an exemplary embodiment of a control device according to the present disclosure;

FIG. 3A-B illustrate exemplary embodiments of an arrangement for household waste according to the present disclosure;

FIG. 4 illustrates a diagram over the relationship between pressure and temperature when controlling an arrangement for household waste according to the present disclosure;

FIG. 5 illustrates an exemplary embodiment of an arrangement for household waste according to the present disclosure;

FIG. 6 illustrates an exemplary embodiment of an arrangement for household waste according to the present disclosure;

FIG. 7A-B illustrate exemplary embodiments of an arrangement for household waste according to the present disclosure;

FIG. 8 illustrates an exemplary embodiment of an arrangement for household waste according to the present disclosure;

FIG. 9 illustrates exemplary embodiments of an arrangement for household waste according to the present disclosure;

FIG. 10 illustrates exemplary embodiments of an arrangement for household waste according to the present disclosure; and

FIG. 11 illustrates an exemplary embodiment of a method for handling household waste by means of an arrangement for household waste according to the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided merely to fully convey the scope of the disclosure to the skilled person.

It is to be understood that the terminology used herein is for purpose of describing particular embodiments only, and is not intended to be limiting. It should be noted that, as used in the specification and the appended claims, the articles “a”, “an”, “the”, and “'said” are intended to mean that there are one or more of the elements unless the context explicitly dictates otherwise. Thus, for example, reference to “a unit” or “the unit” may include several devices, and the like. Furthermore, the terms “comprising”, “including”, “containing” and similar wordings are intended to be open-ended transitional terms that do preclude the possibility of additional elements or steps.

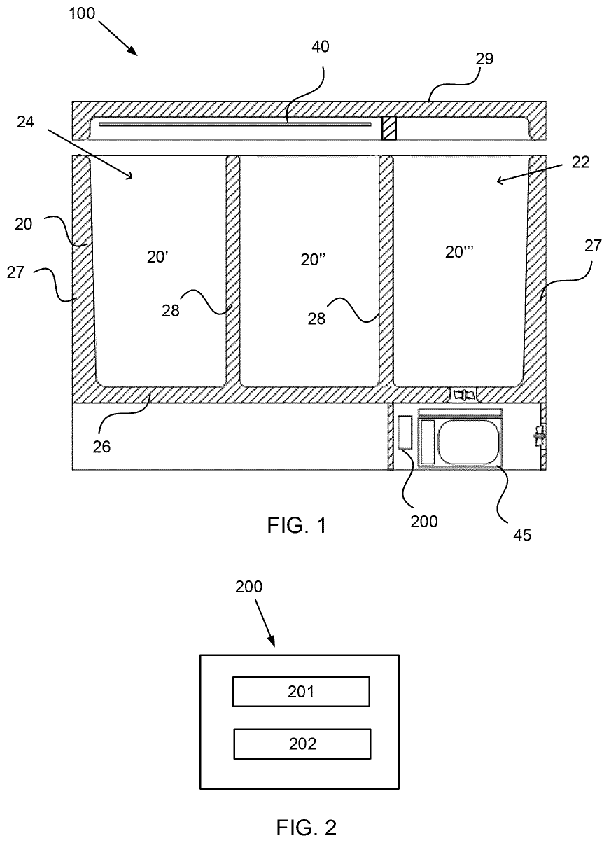

FIG. 1 schematically illustrates an arrangement 100 for household waste according to an exemplary embodiment of the disclosure. The arrangement 100 comprises a container 20 for household waste. The container 20 comprises a bottom wall 26 and side walls 27 extending vertically upwards from the bottom wall 26. The container 20 also comprises a removable cover 29 arranged at the top of the container 20. The container 20 comprises a plurality of chambers 20′, 20″, 20′″. In this example, three chambers are shown but it is to be understood that the container 20 may comprise two chambers or more. Intermediate walls 28 are arranged to delimit/define the different chambers 20′, 20″, 20′″.

The arrangement 100 further comprises a cooling device 40 arranged to provide a desired temperature within the container 20. In this exemplary embodiment, the cooling device 40 comprises a thermoelectric module, such as a Peltier module or pad, arranged in the cover 29. The thermoelectric module is aligned with a first 20′ and a second 20″ chamber. The arrangement 100 also comprises a heating device 45 arranged in communication with the third chamber 20′″. The heating device 45 may, for example, comprise a fan heater including a heating element and a fan for blowing hot air into the chamber 20′″. The container 20 comprises a hot zone 22 for accommodating food residues and a cold zone 24 for accommodating other household waste, such as plastics and/or paper. The cooling device 40 is configured to provide a cold zone temperature in the cold zone. The heating device 45 is configured to provide a hot zone temperature in the hot zone. Thus, the first 20′ and second 20″ chamber form part of the cold zone 24, and the third chamber 20′″ form part of the hot zone 22.

The arrangement 100 further comprises a control device 200 configured to control the cooling device 40 and, optionally, the heating device 45, in order to control the temperature within the container 20.

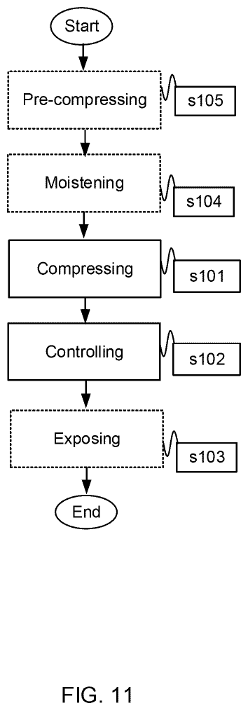

FIG. 2 schematically illustrates an exemplary embodiment of a control device 200 of an arrangement 100 for household waste according to the present disclosure. The control device 200 comprises at least one processor 201 and a storage medium 202. The control device 200 may be configured to perform the method as described in FIG. 11 upon execution of a computer program by the at least one processor 201. The computer program(s) comprise computer-readable instructions that may be stored in the storage medium 202. The storage medium 202 may be a non-transitory hardware memory device of the control device 200.

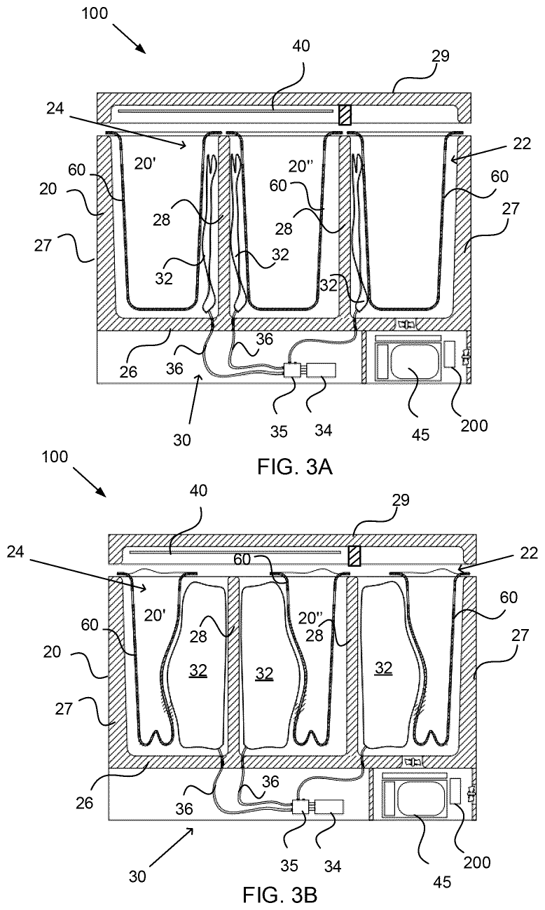

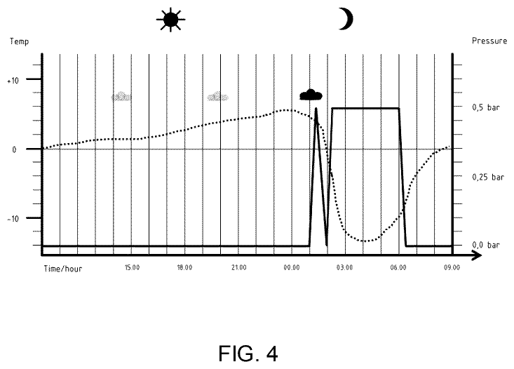

FIG. 3A-B schematically illustrates an arrangement 100 for household waste according to an exemplary embodiment of the disclosure. The arrangement 100 may be configured as disclosed in FIG. 1. In this example, the arrangement 100 further comprises flexible receptacles 60 removably arranged inside the container 20 for receiving the waste. The arrangement 100 also comprises a compression device 30 arranged to compress the waste within the container 20. In this example, the compression device 30 comprises an inflatable element 32 in each chamber 20′, 20″, 20′″, each configured to be inflated to expand and compress the waste within the respective chamber 20′, 20″, 20′″. In this example, the inflatable elements 32 are arranged to compress the waste laterally, essentially perpendicularly to the direction of gravity. FIG. 3A shows the arrangement 100 with the inflatable elements 32 in a deflated state, and thus when the compression device 30 is in a non-compression state. FIG. 3B shows the arrangement 100 with the inflatable elements 32 in an inflated state, and thus when the compression device 30 is in a compression state.

The receptacles 60 are arranged inside the container 20, such that each inflatable element 32 is arranged between a container wall (intermediate wall) 28 and the receptacle 60. The inflatable elements 32 will thereby affect the receptacles 60 when being inflated, and the receptacles 60 will be compressed and thereby compress the waste inside the receptacles 60. The receptacles 60 are in this example arranged, such that they rest on a top edge of the container walls 27, 28. By having the inflatable elements 32 in the first 20′ and second 20″ chamber arranged at the intermediate wall 28, the opposing forces of the inflatable elements 32 on the intermediate wall 28 will cancel each other out. The intermediate wall 28 can thereby be relatively thin and will thus not significantly affect the storage space of the waste.

The figures also show that the compression device 30 comprises an air source 34 for inflating/deflating the inflatable elements 32. The air source 34 will herein be referred to as an air pump 34. The air pump 34 is connected to the inflatable elements 32 via first air passages 36. The compression device 30 may further comprise a valve device 35 arranged in fluid communication with the first air passages 36 and the air pump 34. The valve device 35 is arranged to control the flow of air to and/or from the inflatable elements 32. In this example, the air pump 34 and the valve device 35 are arranged below the bottom wall 26 of the container 20 and do thereby not affect the storage space for the waste inside the container 20.

The control device 200 may be configured to control the compression device 30 in order to regulate a compression force over time. The compression force depend on the level of inflation of the inflatable element 32. Thus, the control device 200 may be configured to control the compression device 30 to regulate the level of inflation of the inflatable elements 32 over time. The control device 200 may be configured to control the air pump 34 and the valve device 35 in order to control the flow of air to/from the inflatable element 32.

FIG. 4 shows a diagram illustrating a temperature-pressure relationship related to a household waste arrangement 100 according to an example. Specifically, the diagram illustrates the relationship between the temperature in the cold zone 24 and a compressing pressure exerting a force on waste in the cold zone 24. More specifically, the diagram illustrates the temperature (dotted line) in the cold zone 24 and the pressure (solid line) within an inflatable element 32 of a compression device 30 in the first or second chamber 20′, 20″ of the cold zone 24, as functions of time. With reference to the previous drawings and the foregoing description, it should be appreciated that the control device 200 of the household waste arrangement 100 may be configured to control the temperature and pressure as illustrated by the diagram and further described below by controlling the operation of the cooling device 40 and the compression device 30.

When the compression device 30 is in a non-compression state, e.g. during daytime when the utilization of the household waste arrangement 100 can be assumed to be high, the temperature in the cold zone 24 is generally kept at a non-freezing temperature above 0 degrees Celsius, preferably in the range of 0-10 degrees Celsius, and most preferably in the range of 0-6 degrees Celsius. After a static compression operation during which the temperature in the cold zone 24 is maintained below zero degrees Celsius (subzero temperature) to freeze the waste, the temperature in the cold zone 24 is gradually increased from the subzero temperature to the non-freezing temperature. A maximum non-freezing temperature is typically obtained slightly before a new static compression operation is performed.

When a static compression operation is to be performed, e.g. during night time when the utilization of the household waste arrangement 100 is low, the temperature is gradually decreased from the non-freezing temperature to the subzero temperature. Before the waste is frozen, a compressing force applied to the waste is gradually increased, for example by increasing the pressure within the inflatable element 32. The pressure is typically increased until a maximum pressure within the inflatable element 32 is reached, corresponding to a maximum compression force applied to the waste. This pressure is maintained during a predetermined period of substantially static compression, illustrated by the pressure plateau between approximately 2.15 AM and 6 AM in FIG. 4. The subzero temperature is maintained during the period of static compression until the compressed waste is at least partly frozen, and preferably fully frozen to form a compact block of frozen waste.

Compression of the waste can hence be said to comprise a phase of dynamic compression and a phase of static compression. Dynamic compression is at the beginning of the compression process when the compression device starts applying a compression force on the waste and the waste is deformed and displaced inside the container. In the illustrated example, dynamic compression starts at 2 AM and ends around 2.15 AM when the phase of static compression begins.

The decrease in temperature from the non-freezing temperature to the subzero temperature may start before, at the same time, or after the start of dynamic compression, depending, e.g., on a current temperature in the cold zone and the rates of change in temperature and pressure. For ice crystals to provide optimal adhesive effect by temporarily gluing compressed waste together, ice crystals should not form to a large extent before the waste is fully compressed, i.e. before the static compression state is initiated. Therefore, the temperature in the cold zone is preferably controlled to fall below zero degrees Celsius after initiation of the phase of static compression, or at the earliest after or in connection with initiation of the phase of dynamic compression.

During static compression, the gradual decrease in temperature may continue until a predetermined minimum temperature is reached. The minimum temperature may be reached when essentially half of the predetermined static compression time has passed. The minimum temperature may be in the range of minus 1 to minus 15 degrees Celsius. When the minimum temperature has been reached, the temperature may be gradually increased while maintaining it below zero at least as long as the static compression is performed. The subzero temperature is thus maintained during the entire phase of static compression. Preferably, the subzero temperature may be maintained also for a certain period of time following the phase of static compression. For example, the subzero temperature may be maintained for a period of 1-3 hours after the phase of static compression. In the illustrated example, the subzero temperature is maintained for approximately 2.5 hours after the phase of static compression.

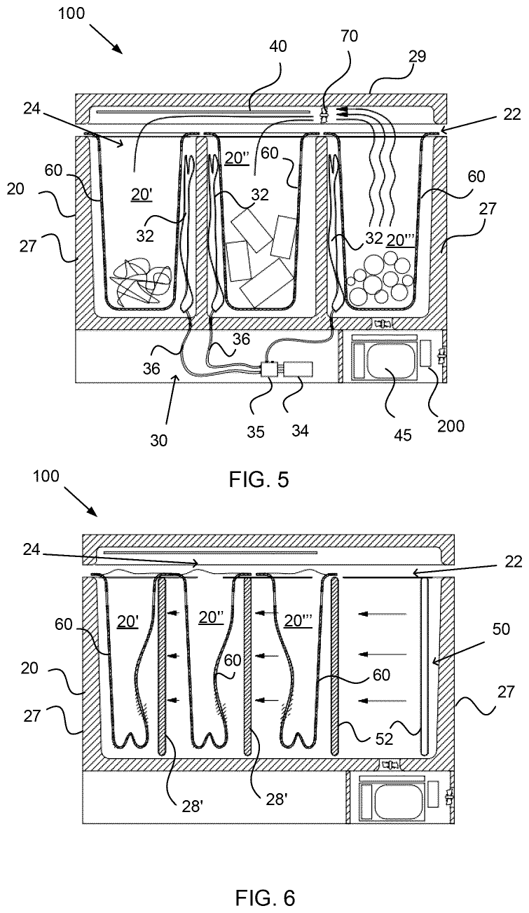

FIG. 5 schematically illustrates an arrangement 100 for household waste according to an exemplary embodiment of the disclosure. The arrangement 100 may be configured as disclosed in FIG. 3A-B. The container 20 comprises a first chamber 20′, a second chamber 20″ and a third chamber 20′″. The first chamber 20′ may comprise plastic household waste, the second chamber 20″ may comprise paper waste and the third chamber 20′″ may comprise food residues. The first and second chamber 20′, 20″ are in the cold zone 24 and the third chamber 20′″ is in the hot zone 22.

This figure illustrates how vapour from evaporation of the food residues in the hot zone 22 is transferred to the cold zone 24 where it condensates on the cold waste and thereby moisten the plastics and the paper. The arrangement 100 comprises a transfer fan 70 arranged between the hot zone 22 and the cold zone 24. The transfer fan 70 may be arranged in the cover 29 of the container 20. The transfer fan 70 may be controlled by the control device 200. By controlling the transfer fan 70, the vapour from the food residues can be used to moisten the household waste in the cold zone 24 in a very efficient way.

FIG. 6 schematically illustrates an arrangement 100 for household waste according to an exemplary embodiment of the disclosure. The arrangement 100 may be configured as disclosed in FIG. 3A-B or 5. In this example, the arrangement 100 comprises an arrangement 50 for alternately exposing the waste in the container 20 for the hot zone 22 and the cold zone 24. By means of such arrangement 50, the waste normally accommodated in the cold zone 24 may be exposed to the hot zone 22 for example prior to compression, and the waste normally accommodated in the hot zone 22 may be exposed to the cold zone 24.

The arrangement 50 for alternately exposing the waste in the container 20 for the hot zone 22 and the cold zone 24 comprises means 52 for displacing household waste between the hot zone 22 and the cold zone 24. In this example, the container 20 comprises two displaceable intermediate walls 28′. During normal conditions, the displaceable intermediate walls 28′ are arranged, such that a first wall 28′ delimits the first chamber 20′ together with a side wall 27 of the container 20, the first and second displaceable intermediate walls 28′ delimits the second chamber 20″, and the second displaceable intermediate wall 28′ delimits the third chamber 20′″ together with a side wall 27 of the container 20. The first and the second chamber 20′, 20″ are normally in the cold zone 24, and the third chamber 20′″ is normally in the hot zone 22. The means 52 for displacing household waste is herein arranged in the third chamber 20″. In this example, the means 52 for displacing household waste is configured as a displaceable intermediate wall as well, but it is to be understood that it could comprise any mechanically, electrically, pneumatically or hydraulically controlled actuator arranged to move inside the container 20.

As shown in the figure, the means 52 for displacing the household waste has been moved in direction of the arrows in the figure and thereby pushed the receptacle 60 in the third chamber 20′″ into the cold zone 24. When the means 52 for displacing the household waste is moved in direction towards the cold zone 24, a force is applied on the receptacle 60 in the third chamber 20′″ and the receptacle 60 will be moved as well. When the receptacle 60 in the third chamber 20′″ is moved it will press on the second displaceable intermediate wall 28′, which will be displaced and press on the receptacle 60 in the second chamber 20″. The receptacle 60 in the second chamber 20″ will in turn press on the first displaceable intermediate wall 28′, which will be displaced and press on the receptacle 60 in the first chamber 20′. Thus, by the means 52 for displacing the household waste, the receptacles 60 and/or the waste will be compressed and moved, the displaceable intermediate walls 28′ will be displaced and the size of the chambers 20′, 20″, 20′″ will be affected, such that all three chambers 20′, 20″, 20′″ fit within the cold zone 24.

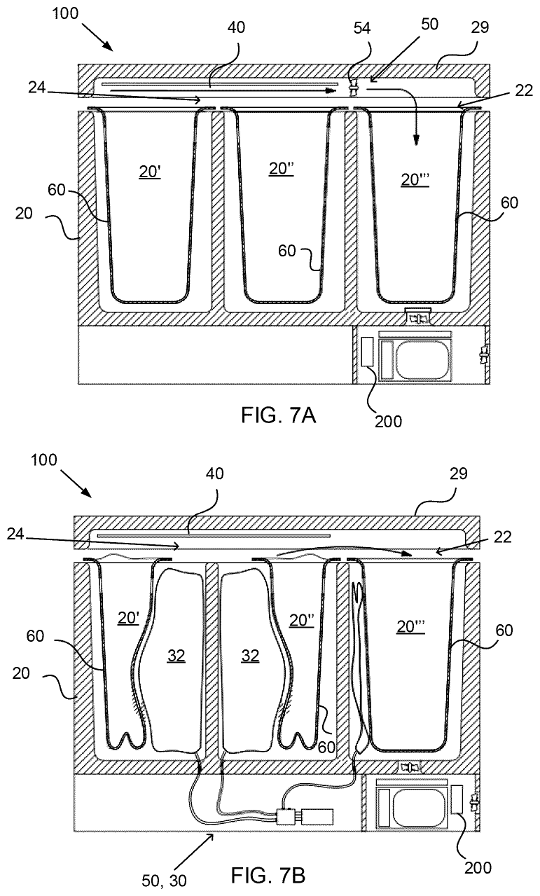

FIGS. 7A and 7B schematically illustrate arrangements 100 for household waste according to exemplary embodiments of the present disclosure. The arrangements 100 may be configured as disclosed in FIG. 3A-B or 5. In these examples, the arrangement 100 comprises an arrangement 50 for alternately exposing the waste in the container 20 for the hot zone 22 and the cold zone 24.

In FIGS. 7A and 7B, the arrangement 50 for alternately exposing the waste in the container 20 for the hot zone 22 and the cold zone 24 comprises means 54, 30 for temporarily expanding the cold zone 24 and/or the hot zone 22 and thereby exposing the household waste for alternating temperatures. The container 20 comprises three chambers 20′, 20″, 20′″ where the first and second chambers 20′, 20″ normally are in the cold zone 24 and the third chamber 20′″ is normally in the hot zone 22. The figures show how the cold zone 24 is expanded by transferring cold air from the cold zone 24 into the hot zone 22. This way, the cold zone 24 will temporarily encompass also the previous hot zone 22.

In FIG. 7A, the means 54 for temporarily expanding the cold zone 24 and/or the hot zone 22 comprises an expansion fan 54 arranged in fluid communication with the hot zone 22 and the cold zone 24. By controlling the expansion fan 54, cold air can be drawn from the cold zone 24 into the hot zone 22 or vice versa. It is to be understood that the expansion fan 54 may be the same as the transfer fan 70 used for transferring vapour from the hot zone 22 into the cold zone 24.

In FIG. 7B, no fan is used to expand the cold zone 24. Instead, the means for temporarily expanding the cold zone 24 and/or the hot zone 22 comprises the compression device 30 of the arrangement 100. To transfer cold air from the cold zone 24 into the hot zone 22 and thereby expand the cold zone 24, the inflatable elements 32 in the first and second chambers 20′, 20″ are inflated. When the inflatable elements 32 are inflated and expand, the receptacles 60 in these chambers 20′, 20″ are compressed and the air in the receptacles 60 is pushed upwards. The cold air will flow into the hot zone 22 as illustrated by an arrow and will due to higher density fall downwards in the hot zone and cool the waste in the third chamber 20′″. Thus, by controlling the compression device 30 (in this case the inflatable elements 32) air from one chamber can be pushed into another chamber and the cold zone 24/hot zone 22 can thereby be temporarily expanded.

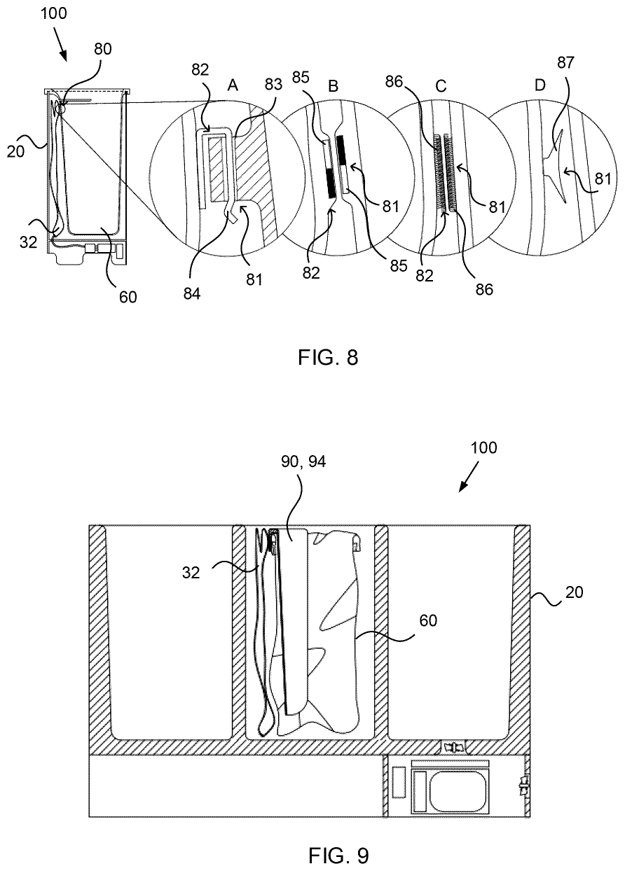

FIG. 8 schematically illustrates an arrangement 100 for household waste according to an exemplary embodiment of the disclosure. The arrangement 100 may be configured as disclosed in FIG. 3A-B, 5, 6 or 7A-B even though only one receptacle 60 and inflatable element 32 is shown. In this example, the arrangement 100 comprises a shape regaining arrangement 80 for facilitating the receptacle 60 to regain its original shape after compression.

The shape regaining arrangement 80 comprises at least a one coupling element 81, 82 arranged to removably attach the receptacle 60 to the inflatable element 32. Different examples of the shape regaining arrangement 80 are shown in A, B, C and D. Example A comprises a first coupling element 81 on the receptacle 60 and a second coupling element 82 on the inflatable element 32, wherein the first coupling element 81 comprises an opening 83, such as a through hole, cavity, aperture, slit, loop or similar, configured to receive the second coupling element 82. The second coupling element 82 comprises a hook 84. By having a first coupling element 81 on the receptacle 60 connected to a second coupling element 82 on the inflatable element 32, the receptacle wall comprising the first coupling element 81 will follow the movement of the inflatable element 32 when it is deflated and the receptacle 60 will this way regain its original shape. It is to be understood that the receiving opening 83 could be arranged on the inflatable element 32 and the hook 84 could be arranged on the receptacle 60.

In example B, the shape regaining arrangement 80 comprises a magnetic coupling, wherein the first coupling element 81 on the receptacle 60 and the second coupling element 82 on the inflatable element 32, both comprises magnets 85.

In example C, the shape regaining arrangement 80 comprises a Velcro coupling, wherein the first coupling element 81 on the receptacle 60 and the second coupling element 82 on the inflatable element 32, both comprises connecting Velcro patches 86.

In example D, the shape regaining arrangement 80 comprises a suction cup coupling. In this example, the at least one coupling element 81, 82 is arranged on the inflatable element 32 and comprises a suction cup 87 configured to be connected to the receptacle 60. However, it is to be understood that the suction cup 87 could be arranged on the receptacle 60 instead of on the inflatable element 32.

Even though FIG. 8 only shows coupling elements 81, 82 connecting the receptacle 60 and the inflatable element 32, the shape regaining arrangement 80 may additionally or alternatively comprise coupling elements 81, 82 connecting the receptacle 60 and the container 20.

FIG. 9 schematically illustrates an arrangement 100 for household waste according to an exemplary embodiment of the disclosure. The arrangement 100 may be configured as disclosed in FIG. 3A-B, 5, 6, 7A-B, or 8. The arrangement 100 also comprises a non-stick arrangement 90 for preventing adhesion between the receptacle 60 and the waste during compression. In this example, the arrangement 100 comprises a non-stick arrangement 90 comprising an intermediate non-stick element 94. The intermediate non-stick element 94 is configured to be arranged between an inner wall of the receptacle 60 and the waste. In this example, the non-stick element 94 is removably attached to the inflatable element 32 of the compression device 30. During compression, one side of the non-stick element 94 will abut the inner wall of the receptacle 60 and the other side of the non-stick element 94 will abut the waste. By using this separate non-stick element 94, any type of flexible receptacle 60 can be used for accommodating the waste. In this figure, a disposable paper or plastic bag is used as receptacle 60.

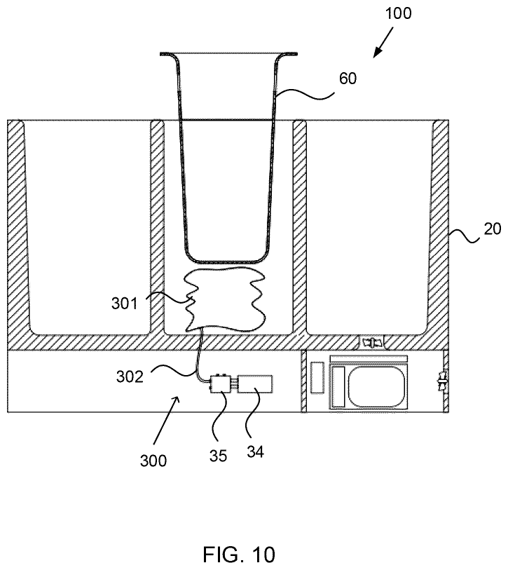

FIG. 10 schematically illustrates an arrangement 100 for household waste according to an exemplary embodiment of the disclosure. The arrangement 100 may be configured as disclosed in FIG. 3A-B, 5, 6, 7A-B, 8 or 9. In this example, the arrangement 100 comprises a lifting arrangement 300 for facilitating lifting the receptacle 60 out of the container 20. The lifting arrangement 300 is typically controlled by means of the control device 200. The lifting arrangement 300 comprises an inflatable lifting element 301 arranged underneath the receptacle 60 inside the container 20. The inflatable lifting element 301 is configured to be inflated to push the receptacle 60 upwards. This is specifically the case when the closable opening for removing/inserting the receptacle 60 from/into the container 20 is arranged at the top of the container 20. The lifting arrangement 300 thus comprises a second air passage 302 connecting the air pump 34 and the inflatable lifting element 301. By controlling the valve device 35, the air provided by the air pump 34 can be directed through the second air passage 302 to inflate the inflatable lifting element 301. The inflatable lifting element 301 is configured, such that it expands upwards when it is inflated. This way, the receptacle 60 will be pushed upwards.

FIG. 11 illustrates an exemplary embodiment of a method for handling household waste by means of an arrangement 100 for household waste according to the present disclosure. The arrangement 100 for household waste may be configured as disclosed in any of FIG. 1-10 and comprises a container 20 for household waste; a compression device 30 arranged in the container 20 for compressing the waste within the container 20; a cooling device 40 arranged to provide a desired temperature within the container 20; and a control device 200. The method comprises the steps of: compressing s101 household waste within the container 20 by means of the compression device 30; and controlling s102 the temperature within the container 20 by means of the cooling device 40, wherein the step of controlling s102 the temperature comprises controlling the cooling device 40 to freeze compressed waste within the container 20. The method is preferably a computer-implemented method performed by means of the control device 200 described herein.

The step of compressing s101 the waste may comprise compressing the waste by means of at least one inflatable element 32 of the compression device 30, which inflatable element 32 is inflated to compress the waste within the container 20.

The step of compressing s101 the waste may comprise compressing the waste laterally, essentially perpendicularly to the gravitational direction of the waste. Alternatively, compressing s101 the waste is performed essentially vertically.

The step of compressing s101 the waste may comprise compressing the waste by compressing a flexible receptacle 60 removably arranged inside the container 20 for receiving the waste.

The step of compressing s101 the waste may comprise controlling the compression device 30, such that the compression device 30 is maintained in a static compression state during a predetermined time period. The user of the arrangement may decide the predetermined time period. The predetermined time period may be at least two hours, preferably at least three hours. The step of compressing s101 the waste may comprise controlling the compression device 30, such that compression is initiated at a specific predetermined time. Compressing s101 the waste may be initiated at a time when the container 20 normally is not used by any person, for example during the night.

The step of controlling s102 the temperature may comprise controlling the cooling device 40 to provide a temperature below 0 degrees Celsius when the compression device 30 is in a static compression state.

The step of controlling s102 the temperature may comprise controlling the cooling device 40 to provide a temperature above 0 degrees Celsius when the compression device 30 is in a non-compression state and/or in a dynamic compression state.

The method may further comprise the step of alternately exposing s103 the waste in the container 20 for a hot zone 22 and a cold zone 24 within the container 20.

The step of exposing s103 the waste in the container 20 for the hot zone 22 and the cold zone 24 within the container 20 may comprise temporarily expanding the cold zone 24 and/or the hot zone 22. This may include controlling an expansion fan 54 to draw hot air from the hot zone 22 into the cold zone 24 or vice versa. Alternatively, this may include controlling the compression device 30 in the hot zone 22 to push hot air in the hot zone 22 over to the cold zone 24, or vice versa.

The step of exposing s103 the waste in the container 20 for the hot zone 22 and the cold zone 24 within the container 20 may alternatively comprise displacing household waste between the hot zone 22 and the cold zone 24. Displacing household waste may be performed by displacing the receptacle 60 comprising the household waste. Displacing the household waste may involve pushing at least one displaceable intermediate wall 52, 28′.

The method may further comprise the step of moistening s104 the waste before compression. Moistening s104 the waste before compression may comprise taking moisture generated by evaporation of food residues in the hot zone 22 to humidify waste in the cold zone 24. Moistening the waste before compression may comprise moistening the waste by means of a humidifying device arranged in fluid connection with the inside of the container 20.

The method may further comprise facilitating that the receptacle(s) 60 regains its original shape after compression, by means of a shape regaining arrangement. Facilitating that the receptacle regains its original shape may comprise generating a pressure difference between the inside of the receptacle and a space between the receptacle and the container as described above. The control device may thus control the shape regaining arrangement, such that a pressure difference between the inside of the receptacle and a space between the receptacle and the container is generated.

The method may further comprise the step of controlling s105 the compression device 30 to perform a pre-compression operation to move the waste around inside the container 20. In the pre-compression operation, the compression device 30 is compressing the waste for a short/brief period of time. This way, the waste will be moved around inside the container 20 and gaps and air pockets may be avoided and once the actual compression starts, the compressed waste may become more compact. The pre-compression operation is preferably performed prior to, or simultaneously as, moistening the waste.

The person skilled in the art realizes that the present disclosure is not limited to the embodiments described above. The person skilled in the art further realizes that modifications and variations are possible within the scope of the appended claims.

1. An arrangement for household waste, the arrangement comprising:
a container for household waste;
a compression device arranged in the container for compressing the waste within the container;
a cooling device arranged to provide a desired temperature within the container; and
a control device configured to control the cooling device to freeze compressed waste within the container.

2. The arrangement according to claim 1, wherein the control device is configured to control the cooling device to provide a temperature below 0 degrees when the compression device is in a static compression state.

3. The arrangement according to claim 1, wherein the control device is configured to control the cooling device to provide a temperature above 0 degrees at least when the compression device is in a non-compression state.

4. The arrangement according to claim 1, wherein the container comprises a hot zone, preferably for accommodating food residues, and a cold zone for accommodating other household waste, such as plastics and/or paper, wherein the cooling device is arranged in communication with the cold zone for enabling freezing the waste.

5. The arrangement according to claim 4, further comprising an arrangement for alternately exposing the waste in the container for the hot zone and the cold zone.

6. The arrangement according to claim 5, wherein the arrangement for alternately exposing the waste in the container for the hot zone and the cold zone comprises:
means for temporarily expanding the cold zone and/or the hot zone and thereby exposing the household waste for alternating temperatures.

7. The arrangement according to claim 5, wherein the arrangement for alternately exposing the waste in the container for the hot zone and the cold zone comprises:
means for displacing household waste between the hot zone and the cold zone and thereby exposing the household waste for alternating temperatures.

8. The arrangement according to claim 1, wherein the arrangement is configured to moisten household waste within the container before compression.

9. The arrangement according to claim 8, wherein the arrangement is configured to take moisture generated by evaporation of food residues in the hot zone to humidify waste in the cold zone.

10. The arrangement according to claim 1, wherein the compression device comprises at least one inflatable element configured to be inflated to compress the waste within the container.

11. The arrangement according to claim 1, further comprising:
at least one flexible receptacle removably arranged inside the container for receiving the waste,
wherein the compression device is arranged to compress the waste by compressing the receptacle.

12. The arrangement according to claim 1, wherein the control device is configured to control the compression device, such that it is maintained in a static compression state during a predetermined time period.

13. The arrangement according claim 1, wherein the control device is configured to control the compression device to perform a pre-compression operation to move around the waste inside the container.

14. A method for handling household waste by means of an arrangement for household waste, the arrangement comprising a container for household waste; a compression device arranged in the container for compressing the waste within the container; a cooling device arranged to provide a desired temperature within the container; and a control device, the method comprising:
compressing household waste within the container by means of the compression device; and
controlling the temperature within the container by means of the cooling device,
wherein the step of controlling the temperature comprises controlling the cooling device to freeze compressed waste within the container.

15. The method according to claim 14, wherein compressing the waste comprises compressing the waste laterally, essentially perpendicularly to the gravitational direction of the waste.

16. The method according to claim 14, wherein controlling the temperature comprises controlling the cooling device to provide a temperature below 0 degrees when the compression device is in a static compression state.

17. The method according to claim 14, wherein controlling the temperature comprises controlling the cooling device to provide a temperature above 0 degrees when the compression device is in a non-compression state and/or in a dynamic compression state.

18. The method according to claim 14, further comprising:
alternately exposing the waste in the container for a hot zone and a cold zone within the container.

19. The method according to claim 18, wherein alternately exposing the waste in the container for a hot zone and a cold zone comprises temporarily expanding the cold zone and/or the hot zone.

20. (canceled)

21. (canceled)

22. (canceled)

23. A computer program for an arrangement for household waste comprising a container for household waste; a compression device arranged in the container for compressing the waste within the container; a cooling device arranged to provide a desired temperature within the container; and a control device comprising at least one processor, the computer program comprising computer-readable instructions which, when executed by the at least one processor causes the arrangement for household waste to perform the steps of the method according to claim 14.
